(19) United States
(12) Patent Application Publication
(10) Pub. No.: US 2015/0146032 A1
(43) Pub. Date: May 28, 2015

(54) LIGHT FIELD PROCESSING METHOD

(71) Applicant: Vidinoti SA, Fribourg (CH)

(72) Inventors: Laurent RIME, Fribourg (CH); Bernard M. ARULRAJ, Fribourg (CH); Keishi NISHIDA, Fribourg (CH)

(73) Assignee: Vidinoti SA, Fribourg (CH)

(21) Appl. No.: 14/087,616

(22) Filed: Nov. 22, 2013

(51) Int. Cl. H04N 7/01; H04N 5/232

(52) U.S. Cl. CPC H04N 7/01; H04N 5/23229
USPC 348/222.1

(57) ABSTRACT

A light field processing method for processing data corresponding to a light field, comprising:
capturing with a plenoptic camera initial data representing a light field in a format dependent from said plenoptic camera;
converting said initial data into converted data representing said light field in a camera independent format;
processing said converted data so as to generate processed data representing a different light field.

### FIELD OF THE INVENTION

The present invention concerns a light field processing method.

### DESCRIPTION OF RELATED ART

Devices to capture a light field are getting more and more popular. Light fields are often captured with plenoptic cameras. Popular examples of plenoptic camera include the Lytro camera for example.

Each plenoptic camera generates data representing the captured light field in a camera dependent format. For example, the Lytro camera represents the light field by a series of matrix; each matrix includes a plurality of cells indicating the intensity of light reaching the micro lenses from various directions. The number of cells corresponds to the number of micro-lenses

Since the format of captured information is different for each device, it is tedious to apply processing on light field data captured by a set of different plenoptic cameras.

### BRIEF SUMMARY OF THE INVENTION

It is therefore an aim of the present invention to define a device independent plenoptic representation on which various post processing methods can be applied, regardless of the plenoptic camera which was used to capture that information.

According to the invention, these aims are achieved by means of a light field processing method for processing data corresponding to a light field, comprising:

capturing with a plenoptic camera initial data representing a light field in a format dependent from said plenoptic camera;

converting said initial data into converted data representing said light field in a camera independent format;

processing said converted data so as to generate processed data representing a different light field.

The use of a camera independent representation for data representing a light field has the advantage for programmers of data processing software that a single method could be programmed for various plenoptic cameras.

### BRIEF DESCRIPTION OF THE DRAWINGS

The invention will be better understood with the aid of the description of an embodiment given by way of example and illustrated by the figures, in which:

FIG. 1A to 1E schematically represent different parametrization methods for light fields.

FIG. 2 illustrates two ray values coming from the same physical point (on the illustration on the left side) and recomputed using the two-planes representation (on the illustration on the right side). U-V plane is representing device main lens plane. Rx-Ry plane is representing observed real world.

FIG. 3 illustrates two ray values coming from two different physical points B, C lying respectively before and after the focal plane 11 (on the illustration on the left side) and recomputed using the two-planes representation (on the illustration on the right side).

FIG. 4 illustrates a first example of plenoptic camera 1 design.

FIGS. 5 and 6 illustrate a second example of plenoptic camera 1 design.

FIG. 7 illustrates a third example of plenoptic camera 1 design.

FIG. 8 illustrates a process for determining the parameters of an unknown plenoptic camera device from the plenoptic representation of a known reference image, here a checkerboard.

FIG. 9 illustrates a two-plane representation of a light field from a scene with objects at different distances.

FIG. 10 illustrates a first method for determining the depth of each point of a scene, using triangulation between a plurality of rays from the same point.

FIG. 11 illustrates light rays emitted by a single physical point A intersecting the two planes Rx-Ry and U-V

FIG. 12 illustrates an epipolar line appearing in U-Rx plot

FIG. 13 shows an example of Gaussian filter for the U-V plane, which diffuses light rays passing through a single point (Rx, Ry) and hitting to the U-V plane.

FIG. 14 illustrates a light ray blurring by a Gaussian filter for the U-V plane.

FIG. 15 illustrates a process of object resizing.

FIG. 16 briefly shows the schematic for a perpendicular plane translation.

### DETAILED DESCRIPTION OF POSSIBLE EMBODIMENTS OF THE INVENTION

### Definitions

Object Focal Plane: plane in a scene, which is parallel to a camera main lens and on which the plenoptic camera is focused.
Image Focal Plane: plane within a camera, which is parallel to the camera main lens and where physical points lying on the Object Focal Plane are projected in focus on the Image Focal Plane.
Focal Plane: when no mention of “Object” or “Image”, it means either one of the Object Focal Plane or Image Focal Plane.

### Representations

A plenoptic function is a function, which describes a light field with multiple parameters as its arguments.

A typical plenoptic function represents the radiance of light emitted from a given position (x, y, z) in 3D space, and observed at a given position (u, v) on a 2D plane, at a given time and wavelength. A plenoptic function P, which represents the intensity of the light ray, takes the following form:

P=P(x,y,z,u,v,t,λ)

where t and λ are the observation time and the wavelength respectively.

Alternatively, one can thinks of the light ray as it was emitted from (x, y, z) with a given angle (θ, φ). The ray is then parameterized as:

P=P(x,y,z,φ,θ,t,λ).

### 4D Plenoptic Function

Not all 7 parameters are mandatory. For example, if all the light rays in a scene are stationary (i.e. t is constant, such as in a still plenoptic picture) and with a single wavelength A, the 7D plenoptic function mentioned above could be reduced to a 5D function. Moreover, assuming that the rays travel through transparent air without being blocked by any object, radiance of a light ray remains constant along its linear path. As a consequence, a light ray can be fully parameterized by four parameters. For instance, a light ray can be represented with the positions of two intersecting points on two pre-defined surfaces. For example, instead of the starting point (x, y, z) and the viewing/observing position (u, v) on another surface, we just need to consider position (x′, y′) on a certain surface where rays pass through and (u, v).

A 4D function Plenoptic function can be formulized as:

P=P(x′,y′,u,v)

where (x′, y′) is the intersecting point of the light ray with a first predetermined surface in the coordinate of the surface, and (u, v) is the intersecting point of the ray with a second predetermined surface.

The parameterisation method for characterizing each light ray of a light field with four parameters (plus time and/or wavelength, when needed) preferably takes the plenoptic camera design into account in order to represent the captured light field meaningfully and be processed easily. For instance, representing light field with parallel planes might be straightforward for common plenoptic camera comprising a main lens, a micro-lens array and a sensor plane arranged parallel to each other. On the other hand, it might be meaningful for spherical plenoptic cameras where multiple cameras are arranged on a sphere to represent light field in a spherical coordinate system.

Preferably, a parametrization method independent of a particular camera design is selected for representing each light rays of a light field. This way, a common parametrization method can be used for representing a light field captured with different types or designs of cameras.

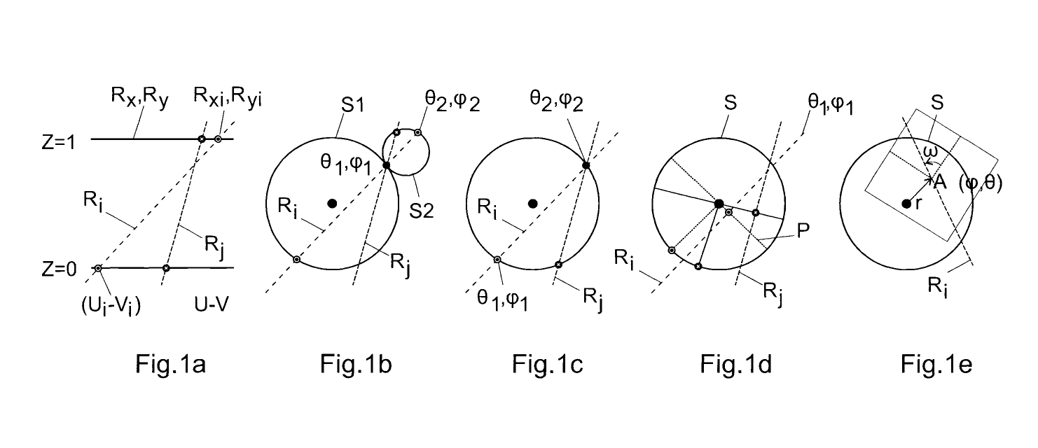

Five camera-independent parameterisation methods of light fields will now be described in relation with FIGS. 1A to 1E: two-planes, spherical, sphere-sphere, sphere-plane and polar respectively.

FIG. 1A illustrates a parametrisation method of a light field with two planes. A ray rᵢ, rⱼ is characterized by the positions where it crosses two planes U-V, Rx-Ry which are parallel to each other. The position on a plane is based on the Cartesian coordinate system for example, or on a polar coordinate system. The first and second planes are placed at z=0, z=1 respectively, where the z axis is perpendicular to the two planes. (Uᵢ, Vᵢ) is the position where Ray rᵢ crosses the first plane U-V and (Rxᵢ, Ryᵢ) is the position where this ray r₁ crosses the second plane Rx, Ry. The radiance P is determined uniquely from the four parameters Uᵢ, Vᵢ, Rxᵢ, Ryᵢ. Taking into account the z axis, the corresponding ray x, y, z is obtained as

$$[ \begin{matrix}x \\ y \\ z\end{matrix} ] = [ \begin{matrix}U + k ( {R}_{x} - U ) \\ V + k ( {R}_{y} - V ) \\ k\end{matrix} ]$$

where k is a parameter that can take any real positive value.

This method is well-suited for plenoptic cameras having an array of micro-lenses and a sensor plane parallel to each other. One drawback of this representation is that it can't represent light rays which travel parallel to the planes U-V, Rx-Ry.

FIG. 1B illustrates a parametrisation method of a light field with two spheres s1, s2 which circumscribe each other. The two spheres s1, s2 are tangent with each other. A ray rᵢ, rⱼ is parameterized by the outgoing intersecting point (φ1, θ1) with a first sphere s1 and the outgoing intersecting point (φ2, θ2) with the second sphere s2 circumscribed with the first sphere at the first intersecting point (φ1, θ1). (φ1, θ1) is the spherical coordinate with respect to the first sphere and (φ2, θ2) is the spherical coordinate with respect to the second sphere. The ray r is obtained as the line passing through the two points:

$$[ \begin{matrix}x \\ y \\ z\end{matrix} ] = [ \begin{matrix}sin ( {θ}_{1} ) cos ( {φ}_{1} ) \\ sin ( {θ}_{1} ) sin ( {φ}_{1} ) \\ cos ( {θ}_{1} )\end{matrix} ] + k [ \begin{matrix}sin ( {θ}_{2} ) cos ( {φ}_{2} ) + sin ( {θ}_{1} ) cos ( {φ}_{1} ) \\ sin ( {θ}_{2} ) sin ( {φ}_{2} ) + sin ( {θ}_{1} ) sin ( {φ}_{1} ) \\ cos ( {θ}_{2} ) + cos ( {θ}_{1} )\end{matrix} ]$$

This representation is useful in the case of a plenoptic image captured by an array of cameras arranged on a sphere. This type of camera is typically used for capturing street views. Another advantage of this representation is that all the light rays which intersect the spheres can be described with this representation. However, rays which do not intersect this sphere can't be represented.

FIG. 1C illustrates a parametrisation method of a light field with one single sphere s. It uses two intersecting points (φ1, θ1), (φ2, θ2) of each ray with the sphere s. Assuming that the radius of the sphere s is large enough for the light field, all the rays can be characterized by four angular parameters (φ1, θ1), (φ2, θ2). A ray is obtained as

$$[ \begin{matrix}x \\ y \\ z\end{matrix} ] = [ \begin{matrix}sin ( {θ}_{1} ) cos ( {φ}_{1} ) \\ sin ( {θ}_{1} ) sin ( {φ}_{1} ) \\ cos ( {θ}_{1} )\end{matrix} ] + k [ \begin{matrix}sin ( {θ}_{2} ) cos ( {φ}_{2} ) - sin ( {θ}_{1} ) cos ( {φ}_{1} ) \\ sin ( {θ}_{2} ) sin ( {φ}_{2} ) - sin ( {θ}_{1} ) sin ( {φ}_{1} ) \\ cos ( {θ}_{2} ) - cos ( {θ}_{1} )\end{matrix} ]$$

This representation is bijective with the spherical representation of FIG. 1B, thus both representations can be convertible to each other without any information loss. Accordingly, its advantages and drawbacks are equivalent to those of the spherical representation.

FIG. 1D illustrates a parametrisation method of a light field with one sphere s and one plane P. A ray r, is represented with the intersecting point (x, y) with the plane P and the angle (φ, θ) of the ray with respect to the sphere coordinate. The plane P is chosen perpendicular to the ray rᵢ and passes through the center of the sphere such that its normal can be represented by a position on a directional sphere.

This sphere-plane representation can represent light rays from any position towards any direction, whether or not it crosses the sphere, in contrast to the representations mentioned above. However, the conversion from the sphere-plane representation to the Cartesian coordinate is more complex than the previous representations.

In the polar representation of FIG. 1E, a ray rᵢ is represented with the following four parameters: r, φ, θ, ω. r is the distance between the origin of the coordinate and the closest point A on the ray. (φ, θ) is the coordinate of the closest point A in the spherical coordinate. ω is the angle of the ray within the plane p in which the ray lies, where the plane is perpendicular to the vector from the origin to the closest point A.

The polar representation is bijective with the sphere-plane representation thus all the rays fairing in every directions and intersecting or not with the sphere can be represented. Nevertheless, the representation might sound less intuitive since one parameter is distance, the other three are angles from different center points. Similarly to the Sphere plane representation, the conversion to the Cartesian coordinate is complex.

All those parametrization representations or formats are camera independent in the sense that a conversion to any one of those representations is possible from any plenoptic data captured with any plenoptic camera, independently of the camera design. However, as indicated, some representations are more adapted to some camera and require less processing for the conversion.

### Plenoptic Data Conversion

Since all the above described representations parametrize light ray information captured in the same condition, one can convert from one representation of plenoptic data to the other ones.

Data conversion from one representation to another one can be used to facilitate data processing. For instance, it might be hard to apply a depth reconstruction algorithm on plenoptic data in the spherical representation, while it is less complex in the two-plane representation. Therefore, when willing to compute depth from plenoptic data stored in a spherical representation, one can first convert from the spherical representation to the two-plane representation before applying depth reconstruction algorithm within the two-planes representation. More generally, processing a lightfield might comprise a step of converting a lightfield representation from a first camera independent representation to a different camera independent representation better adapted for the processing

Since plenoptic data is a set of light rays represented as lines, the conversion from one representation to another one is equivalent to the conversion of the parameters of lines in a coordinate system to the corresponding parameters in another coordinate system.

### General Approach for Conversion

The conversion of representation format algorithms depends on the input and output data representation. However, the approaches can be summarized generally into the following conversion method.

### Conversion Method

For each light ray represented as 4 parameters p1, p2, p3, p4 in the original coordinate:
1. Convert the line parameter p1, p2, p3, p4 into the corresponding line L in the Cartesian coordinate
2. Extract features of line L with respect to the destination coordinate (e.g. find intersecting points with a sphere)
3. Convert the features to corresponding 4 parameters q1, q2, q3, q4 in the destination coordinate
4. Assign P(p1, p2, p3, p4) to P(q1, q2, q3, q4)

We will now describe as an example a method of conversion between a two plane representation to a sphere-sphere representation.

For each light ray in the two-plane representation (Rx, Ry, U, V), do the following:
1. Convert four parameters to two points in the 3D cartesian coordinate, (Rx, Ry, 1) and (U, V, 0) and calculate the line which passes through the two points as,

$$[ \begin{matrix}x \\ y \\ z\end{matrix} ] = [ \begin{matrix}U + k ( {R}_{x} - U ) \\ V + k ( {R}_{y} - V ) \\ k\end{matrix} ]$$

where k is a parameter which can take an arbitrary real number.
2. Compute the intersecting points of the line and the sphere. We consider the sphere having a radius of 1. It gives

$$[ \begin{matrix}{x}_{1} \\ {y}_{1} \\ {z}_{1}\end{matrix} ] = [ \begin{matrix}U + {k}_{1} ( {R}_{x} - U ) \\ V + {k}_{1} ( {R}_{y} - V ) \\ {k}_{1}\end{matrix} ] \\ [ \begin{matrix}{x}_{2} \\ {y}_{2} \\ {z}_{2}\end{matrix} ] = [ \begin{matrix}U + {k}_{2} ( {R}_{x} - U ) \\ V + {k}_{2} ( {R}_{y} - V ) \\ {k}_{2}\end{matrix} ]$$

where k1 and k2 is the solutions of the following equation which is obtained by substituting x, y, z in the step b to the formula of sphere x̂2+ŷ2+ẑ2=1:

((Rₓ−U)²+(R_{y}−V)²+1)k²+2(U(Rₓ−U)+V(R_{y}−V))k+(Rₓ−U)²+(R_{y}−V)²−1=0
3. Convert the two intersecting points to the spherical coordinate as,

$$[ \begin{matrix}{θ}_{1} \\ {φ}_{1}\end{matrix} ] = [ \begin{matrix}{cos}^{- 1} ( {z}_{1} ) \\ {tan}^{- 1} ( \frac{{y}_{1}}{{x}_{1}} )\end{matrix} ] \\ [ \begin{matrix}{θ}_{2} \\ {φ}_{2}\end{matrix} ] = [ \begin{matrix}{cos}^{- 1} ( {z}_{2} ) \\ {tan}^{- 1} ( \frac{{y}_{2}}{{x}_{2}} )\end{matrix} ]$$

4. As a result, we obtain light ray L(φ1, θ2, φ2, θ2) converted from each light ray P(Rx, Ry, U, V) as:

P(φ1,θ2,φ2,θ2)=P(Rₓ,R_{y},U,V)

### Camera-Dependent to Camera-Independent Representation Conversion

We will now describe different examples on how to convert plenoptic data captured with a plenoptic camera device into plenoptic data independent of the device. Examples for several plenoptic cameras available today on the market are described. The plenoptic cameras considered are the Lytro, the Raytrix and the Pelican Imaging ones (all registered trademarks). Each camera uses a different optical design.

In this example, we will describe the conversion to a device independent two-plane representation. Converting to another representation is also possible. The two-plane representation better suits plenoptic capture devices designed with parallel planes to capture the light rays.

We will refer to the two planes of the target representation as Rx-Ry and U-V. The U-V plane could correspond to the plenoptic camera device 1 main lens 10 plane (i.e. the micro-cameras main lens plane in the case of a Pelican Imaging camera). The Rx-Ry plane is parallel to the U-V plane; it is a normalized version of the object focal plane(s) 14 of the plenoptic cameras at the instant of the capture. A coordinate system might be defined so that the U-V plane is at Z=0 and the Rx-Ry plane at Z=1.

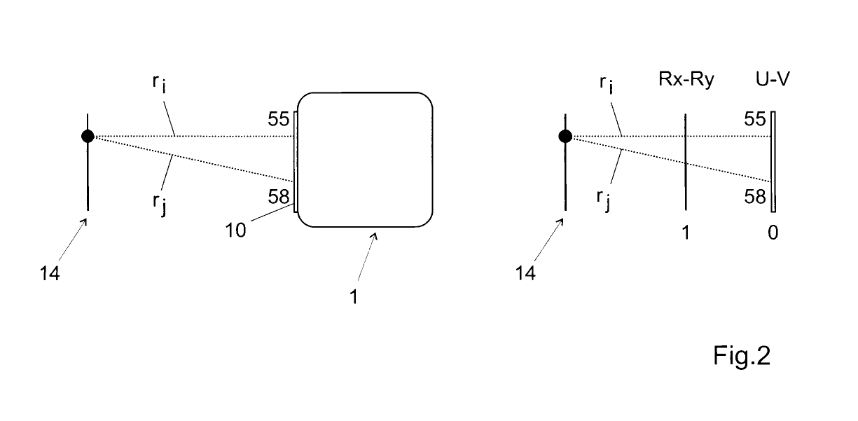

FIG. 2 illustrates two rays rᵢ, rⱼ coming from the same physical point A (on the illustration on the left side) and recomputed using the two-planes representation (on the illustration on the right side). The U-V plane represents the normalized camera device main lens 10 plane. The Rx-Ry plane represents the normalized scene (real world) 14.

The normalization process to go from the object A focal plane 14 to the Rx-Ry plane corresponds to moving the object focal plane 14 of the camera 1 to Z=1 and then to recompute the new intersections of the captured rays rᵢ, rⱼ with this new plane (i.e. Rx-Ry). In the case of Raytrix or Pelican Imaging, where several focal length are used for the micro-lenses or the micro-cameras), the normalization is done for each object focal plane (given by each different lens focal length). This corresponds to moving each different object focal plane to Z=1 and then recomputing the intersections of the rays with this new plane (i.e. Rx-Ry).

Despite the fact that the light field is captured with a discrete plenoptic camera 1, the two planes U-V, Rx-Ry are considered in a continuous space. Indeed, this ensures that rays rᵢ, rⱼ captured by different cameras (i.e. with different intrinsic parameters) can be all represented on the same continuous representation without loss of information. This does obviously not restrict one to decide to discretize this space for some processing or rendering for instance.

FIG. 2 illustrates two rays rᵢ, rⱼ coming from a physical point A. The registered light field data contain the intensity and the direction of all light rays. That stored light field data has anyway the inconvenient to be device dependent. The physical point A on the focal plane is seen by the plenoptic camera device 1 by the two rays rᵢ, rⱼ which intensities might be different in the case where that physical point reflects different rays depending on the angle of view (principle of a non-lambertian surface). Both rays rᵢ, rⱼ are coming from the focal plane 14 and each of them has a specific intensity and direction. The fact that they are coming from the same physical point A is not known anymore. Some algorithms will be described later to match rays with physical points, and hence to derive depth information.

These recorded rays rᵢ, rⱼ can be represented using the previously described two-plane representation. The main lens of the device 1 is represented by the U-V plane. The scene is represented by the Rx-Ry plane. Recorded rays are described with the positions where they cross these both planes. The Rx-Ry plane is positioned relatively to the U-V plane at a distance Z=1. Since the distance between the focal plane 14 and U-V plane and rays directions is known, the crossing positions between the two rays and the planes can be computed. Rx (resp. Ry) is the coordinate on the Rx-Ry Plane in the x (resp. y) direction where one ray intersects the plane. Similarly, U and V corresponds to the intersection of one ray with the U-V Plane.

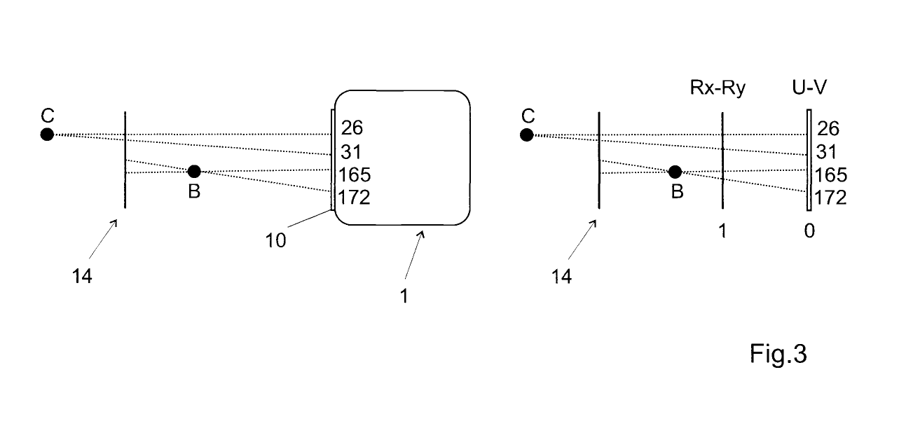

FIG. 3 illustrates two ray values coming from two different physical points B, C lying respectively before and after the focal plane 14 (on the illustration on the left side) and recomputed using the two-planes representation (on the illustration on the right side). The capture device 1 does not know where the physical point lies. A point might for example be before, on, or after the focal plane, and still generates the same ray light on the camera.

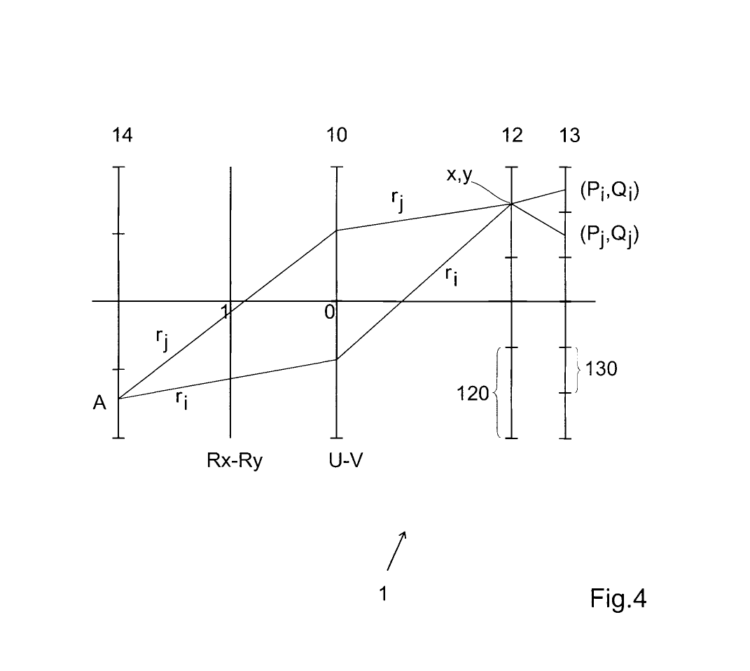

We will now describe in relation with FIG. 4 an example of a device 1 with a design corresponding to one plenoptic camera sold by Lytro (registered trademark).

This plenoptic camera device 1 comprises a main lens 10 which focuses light rays rᵢ, rⱼ on an array of micro-lenses 12 right in front of the camera sensor plane 13. Reference 14 is the object focal plane and the main lens plane is designated with U-V. The Rx-Ry plane represents the scene at a distance 1 from the camera main lens plane U-V. Since the main lens focuses 10 on the micro-lens array 12, rays rᵢ, rⱼ intersecting on the micro-lens array 12 also intersect on the focal plane 14 of the camera. Each micro-lens forms on the sensor 13 a micro-image that does not overlap with the neighbouring micro-image. The focal length of all micro-lenses are the same. The micro-lenses 12 are significantly small as compared to the main lens (for example about 300 times smaller) and placed at a distance such that the main lens 10 is at the optical infinity of the micro-lenses. This design gives the interesting property that directions of light rays reaching a same micro-lens correspond to different view angles of a physical point belonging to a focused object in the scene. In other words, each physical point of a focused object sees all its light rays captured by a single micro-lens and therefore stored on the sensor 13 in a single micro-image, each pixel of the micro-image corresponding to a different ray direction of that physical point.

Each micro-image on the sensor 13 plane corresponds to one micro-lens and has coordinates X and Y. Each pixel within a micro-image as coordinates P and Q. Each micro-image is indexed relatively to the optical axis. Pixels in a given micro-image are indexed relatively to the micro-lens optical axis. Assume that Nₓ (resp. N_{y}) corresponds to the number of micro-images in the x (resp. y) directions and Nₚ (resp. N_{y}) correspond to the number of pixels within a micro-image in the x (resp. y) directions. Furthermore, parameters can be then formalized as follow:

$$- ⌊ \frac{{N}_{x}}{2} ⌋ \leq X \leq ⌊ \frac{{N}_{x}}{2} ⌋ \\ - ⌊ \frac{{N}_{y}}{2} ⌋ \leq Y \leq ⌊ \frac{{N}_{y}}{2} ⌋ \\ - ⌊ \frac{{N}_{p}}{2} ⌋ \leq P \leq ⌊ \frac{{N}_{p}}{2} ⌋ \\ - ⌊ \frac{{N}_{q}}{2} ⌋ \leq Q \leq ⌊ \frac{{N}_{q}}{2} ⌋$$

The ray rᵢ hits a micro-lens 120 identified with its (X;Y) coordinates. The selected pixel 130 within a micro-image where the ray rᵢ hits is described using its (Pᵢ;Qᵢ) coordinates. The area within the main lens 10 where the ray pass through is identified with its (U;V) coordinates. The intersection of Rx-Ry plane with the ray rᵢ hitting the main lens 10 of the device at (U;V) with a specific direction is described using (Rx;Ry) coordinates. For each ray, coordinates on the Rx-Ry plane (Rx;Ry) and coordinates on the main lens (U;V) have to be determined using known device parameters which are the micro-lens coordinates (X;Y) where the ray is passing through and the pixel coordinates (P;Q) in the micro-image.

A transformation for transforming the captured ray expressed using device dependent parameters to a device independent plane-plane representation can be formalized as follows:

$$U = ( - P + {offset}_{P} ) \times \frac{mainlens {size}_{x}}{{N}_{p}}$$

$${R}_{x} = \frac{{object}_{{x}_{coord}} - u}{{dist}_{mainlens / object}} \times {dist}_{Rx - plane} + U$$

$$where , \\ {object}_{{x}_{coord}} = \frac{coord \times f}{{dist}_{mainlens - microlens} - f}$$

$${coord}_{selected microlens} = \frac{microlens plane size}{{N}_{x}} \times ( - X + {offset}_{x} )$$

$${offset}_{p} = - sign ( P ) \times \frac{1}{2} \times ( 1 - mod ( {N}_{p} , 2 ) )$$

$${offset}_{x} = - sign ( X ) \times \frac{1}{2} \times ( 1 - mod ( {N}_{x} , 2 ) )$$

$$V = ( - Q + {offset}_{q} ) \times \frac{mainlens {size}_{y}}{{N}_{q}}$$

$${R}_{y} = \frac{{object}_{{y}_{coord}} - v}{{dist}_{mainlens - microlens}} \times {dist}_{Ry - plane} + V$$

$$where , \\ {object}_{{y}_{coord}} = \frac{{coord}_{{y}_{selected microlens}} \times f}{{dist}_{mainlens - microlens} - f}$$

$${coord}_{selected microlens} = \frac{microlens plane size}{{N}_{y}} \times ( - Y + {offset}_{y} )$$

$${offset}_{q} = - sign ( Q ) \times \frac{1}{2} \times ( 1 - mod ( {N}_{q} , 2 ) )$$

$${offset}_{y} = - sign ( Y ) \times \frac{1}{2} \times ( 1 - mod ( {N}_{y} , 2 ) )$$

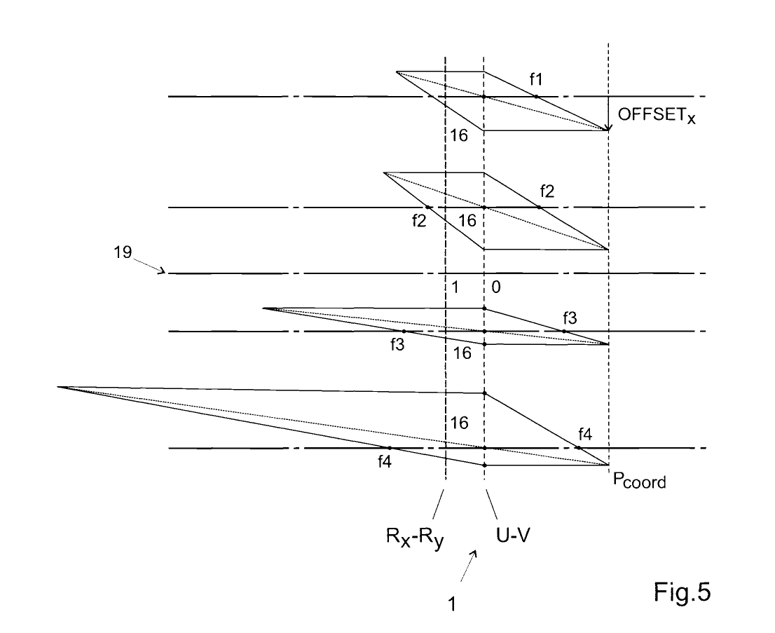

We will now describe with FIGS. 5 and 6 an example of plenoptic camera design similar to the one proposed by Pelican (registered trademark).

The plenoptic capture device 1 of FIG. 5 comprises an array of micro-cameras 16 whose lenses are aligned on a same plane U-V and preferably equidistant to each other. These micro-cameras 16 are thin and therefore could be integrated within mobile devices such as portable computers, palmtops, smartphones or similar devices. Several, for example four on the illustrated example, different camera types with different focal lengths f₁, f₂ could be used, such that this plenoptic camera captures more angular information. Each micro-camera captures a subview of a scene from a slightly different position and focal length. The light field is therefore created by combining the images of the different micro-cameras.

The reference 19 designates a synthetic optical axis from where all positions are computed in the formulas.

Each micro-camera 16 captures a subview of the scene. By aligning the micro-camera plane 160 with the U-V plane, each micro-camera captures the rays hitting a specific U-V coordinate. This corresponds to considering only the rays hitting a specific U-V coordinate but coming from all possible Rx-Ry coordinates, i.e., looking at the scene from a specific position on the U-V plane.

Since every micro-camera 16 has a different focal length f₁, f₂, . . . , the focal planes 14 need to be normalized individually in order to form the Rx-Ry plane.

Each micro-camera 16 can be defined by its coordinates X and Y, each pixel within a micro-camera is described using P and Q. Furthermore,

$$- ⌊ \frac{{N}_{x}}{2} ⌋ \leq X \leq ⌊ \frac{{N}_{x}}{2} ⌋ \\ - ⌊ \frac{{N}_{y}}{2} ⌋ \leq Y \leq ⌊ \frac{{N}_{y}}{2} ⌋ \\ - ⌊ \frac{{N}_{p}}{2} ⌋ \leq P \leq ⌊ \frac{{N}_{p}}{2} ⌋ \\ - ⌊ \frac{{N}_{q}}{2} ⌋ \leq Q \leq ⌊ \frac{{N}_{q}}{2} ⌋$$

where Nₓ (resp. N_{y}) corresponds to the number of micro-cameras in the x (resp. y) directions and Nₚ (resp. N_{y}) correspond to the number of pixels within a micro-camera in the x (resp. y) directions.

Each micro-camera 16 is indexed relatively to the synthetic optical axis 19. Pixels position for each micro-camera is also converted relative to that synthetic optical axis. Computed Rx Ry positions on Rx-Ry plane and U V positions on U-V plane are also relative to that axis.

As shown on FIG. 6, each captured ray rᵢ, rⱼ can be represented on both planes, in the U-V plane with a pair of coordinates (U;V), and in the Rx-Ry plane using (Rx;Ry) coordinates. The ray first hits the micro-camera U-V plane, described using (U;V) coordinates. Then, that ray hits the sensor 13 at a specific coordinates (P;Q) describing the position of the ray within the selected micro-image. Coordinates (Rx;Ry) is actually obtained using recorded (P;Q) coordinates and considering micro-cameras relative offsets as follows:

$$U = microcam {size}_{x} \times ( X + {offset}_{x} )$$

$${R}_{x} = \frac{\frac{cam sensor {size}_{x}}{{N}_{p}} \times ( - P + {offset}_{x} )}{{dist}_{mainlens - sensor}} \times {dist}_{{R}_{x} - plane} + U$$

$$where , \\ {offset}_{x} = - sign ( X ) \times \frac{1}{2} \times ( 1 - mod ( {N}_{x} , 2 ) )$$

$$V = microcam {size}_{y} \times ( Y + {offset}_{y} )$$

$${R}_{y} = \frac{\frac{cam sensor {size}_{y}}{{N}_{q}} \times ( - Q + {offset}_{y} )}{{dist}_{mainlens - sensor}} \times {dist}_{{R}_{y} - plane} + U$$

$$where$$

$${offset}_{y} = - sign ( Y ) \times \frac{1}{2} \times ( 1 - mod ( {N}_{y} , 2 ) )$$

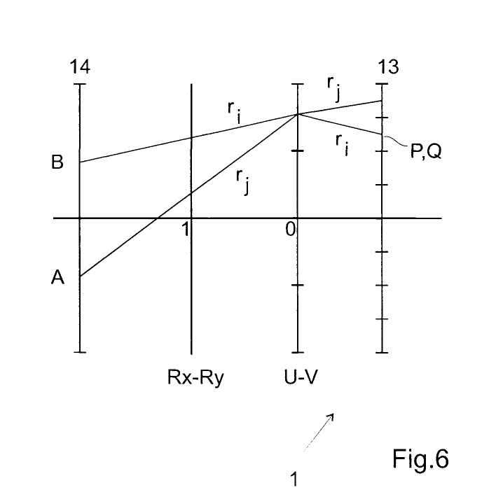

FIG. 7 illustrates an example of plenoptic camera 1 design that could correspond the plenoptic camera proposed by Raytrix (registered trademark). This camera 1 comprises a main lens 10 focusing the light rays rᵢ, rⱼ, rₖ on the image focal plane 15 within the camera. An array of micro-lenses 12 is focused on the image focal plane 15 and located behind it. The micro-lenses 12 then converge the rays on the camera sensor 13. Each micro-lens looks at the scene of the image focal plane 15 with a different view angle. A point A in focus on the object image plane 14 is therefore imaged on the image focal plane 15, which is observed from different view positions by the micro-lenses 12. Several, for example three different types of focal length are used for the micro-lenses. Therefore they focus on three different image focal plane 15 which results in an increased captured angular information.

Each micro-image on the sensor plane 13 might be identified by its coordinates X and Y, each pixel within a micro-image as P and Q. Furthermore,

$$- ⌊ \frac{{N}_{x}}{2} ⌋ \leq X \leq ⌊ \frac{{N}_{x}}{2} ⌋ \\ - ⌊ \frac{{N}_{y}}{2} ⌋ \leq Y \leq ⌊ \frac{{N}_{y}}{2} ⌋ \\ - ⌊ \frac{{N}_{p}}{2} ⌋ \leq P \leq ⌊ \frac{{N}_{p}}{2} ⌋ \\ - ⌊ \frac{{N}_{q}}{2} ⌋ \leq Q \leq ⌊ \frac{{N}_{q}}{2} ⌋$$

where Nₓ (resp. N_{y}) corresponds to the number of micro-images in the x (resp. y) directions and Nₚ (resp. N_{y}) correspond to the number of pixels within a micro-image in the x (resp. y) directions.

Each micro-image is indexed relatively to a main lens optical axis and pixels in a given micro-lens are indexed relatively to the micro-lens optical axis.

Each captured ray rᵢ, rⱼ, rₖ has to be represented on both planes, in the U-V plane with a pair of coordinates (U;V), in the Rx-Ry plane using (Rx;Ry) coordinates. That ray is first captured using device parameters. The ray first hits the main lens plane 10 considered as U-V plane, described using (U;V) coordinates. That ray hits then a specific micro-lens 12 described using (X;Y). Then, it hits the sensor 13 at a specific coordinates (P;Q) describing the position of the ray within the selected micro-image.

Coordinates (Rx;Ry) could be obtained using recorded (P;Q) and (X;Y) coordinates as follows:

$$U = \frac{( {coord}_{{x}_{selected microlens}} - {coord}_{{x}_{selected pixel on pixel}} )}{{dist}_{microlens - sensor}} \times {dist}_{microlens - sensor} + {coord}_{{x}_{selected pixel on pixel}}$$

$${R}_{x} = \frac{{object}_{{x}_{coord}} - u}{{dist}_{mainlens - object}} \times {dist}_{Rx - plane} + U$$

$$where$$

$${Object}_{{x}_{coord}} = - \frac{{im}_{{x}_{coord}}}{image focal distance} \times {dist}_{object focal plane}$$

$${im}_{{x}_{coordinate}} = \frac{( {coord}_{{x}_{selected microlens}} - {coord}_{{x}_{selected pixel on sensor}} )}{{dist}_{microlens - sensor}} \times ( {dist}_{mainlens - sensor} - {dist}_{image focal dist} ) + {coord}_{{x}_{selected pixel on sensor}}$$

$${coord}_{{x}_{selected microlens}} = \frac{microlens plane {size}_{x}}{{N}_{p}} \times ( P + {offset}_{p} )$$

$${coord}_{{x}_{selected pixel on sensor}} = {coord}_{{x}_{selected microlens}} + \frac{sensor plane {size}_{x}}{{N}_{x}} \times ( X + {offset}_{x} )$$

$${offset}_{p} = - sign ( P ) \times \frac{1}{2} \times ( 1 - mod ( {N}_{p} , 2 ) )$$

$${offset}_{x} = - sign ( X ) \times \frac{1}{2} \times ( 1 - mod ( {N}_{x} , 2 ) )$$

$$V = \frac{( {coord}_{{y}_{selected microlens}} - {coord}_{{y}_{selected pixel on sensor}} )}{{dist}_{microlens - sensor}} \times {dist}_{microlsens - sensor} + {coord}_{{y}_{selected pixel on sensor}}$$

$${R}_{y} = \frac{{object}_{{y}_{coord}} - V}{{dist}_{mainlens - object}} \times {dist}_{Ry - plane} + V$$

$$where , \\ {Object}_{{y}_{coord}} = - \frac{{im}_{{y}_{coord}}}{image focal distance} \times {dist}_{object focal plane}$$

$${im}_{{y}_{coordinate}} = \frac{( {coord}_{{ }_{selected microlens}} - {coord}_{{ }_{selected pixel on sensor}} )}{{dist}_{microlens - sensor}} \times ( {dist}_{mainlens - sensor} - {dist}_{image focal dist} ) + {coord}_{{ }_{selected pixel on sensor}}$$

$${coord}_{{y}_{selected microlens}} = \frac{microlens plane {size}_{y}}{{N}_{p}} \times ( Q + {offset}_{q} )$$

$${coord}_{{y}_{selected pixel on sensor}} = {coord}_{{y}_{selected microlens}} + \frac{sensor plane {size}_{y}}{{N}_{y}} \times ( Y + {offset}_{y} )$$

$${offset}_{q} = - sign ( Q ) \times \frac{1}{2} \times ( 1 - mod ( {N}_{q} , 2 ) )$$

$${offset}_{y} = - sign ( Y ) \times \frac{1}{2} \times ( 1 - mod ( {N}_{y} , 2 ) )$$

In the case of a general plenoptic camera where it is not possible to derive the camera conversion function theoretically due to unknown or too complex camera structure, a conversion function can still be acquired by measuring the characteristics of camera system. For example, one can measure how a scene is captured and stored in a plenoptic camera by using a reference scene whose parameters are perfectly known.

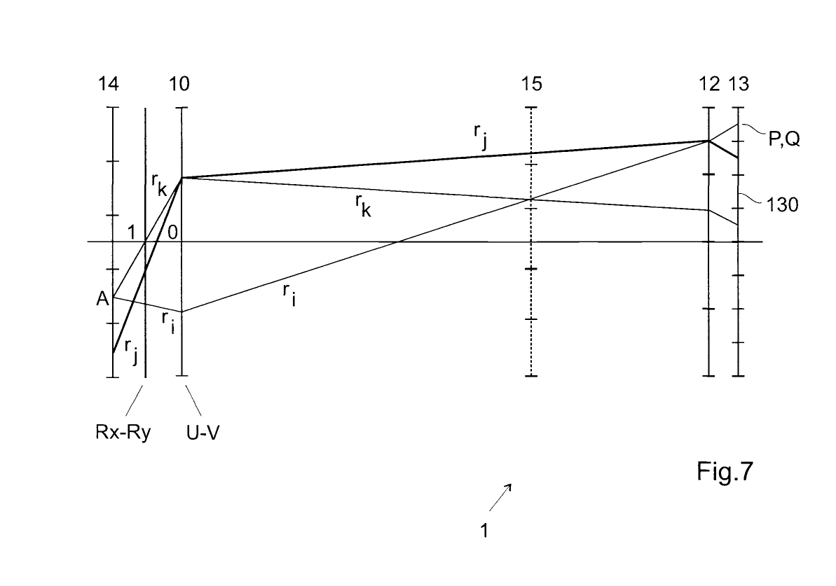

As an example, if we want to determine a conversion function for a camera 1 with at least some unknown parameters, we can identify the camera conversion function F by inferring the unknown parameters in a similar way to camera calibration. As illustrated on FIG. 8, a plenoptic image 21 of a checkerboard 20 captured with the unknown plenoptic camera 1 could be used to determine the parameters of the camera 1. For instance, if one knows that the design of the camera 1 model is identical to the design of a known camera but only its focal distance is unknown, we can infer the focal distance by moving the reference image along the optical axis and find the position where all the rays from the same physical point composes one single micro-image.

As another approach, assuming we don't know the camera design nor its parameters, we can use a device which can emit a single light ray towards a certain direction (e.g. a sharp laser pointer) to find the correspondence with a pixel of plenoptic data. This single light ray is then captured by a plenoptic camera. This approach is different from the previous one by the fact that the plenoptic camera records only one single ray from the emitting device, whereas previously, it was recording several rays fairing from the same physical point. The captured light ray goes into the plenoptic camera and eventually hits a single pixel. We can observe that pixel which has an intensity value different from the others of the scene. Measuring the correspondences between several emitted ray directions and their corresponding pixel lets us define the conversion map, which leads to the conversion function. It is possible to emit several rays successively, and/or simultaneously in different wavelengths and/or modulations, in order to determine the pixels of the plenoptic cameras that are hit by each light ray, and thus determine the conversion function.

### Standard-to-Light-Field Conversion

It is also possible to convert standard 1D, 2D or 3D image data, or stereoscopic data, into camera independent plenoptic representations, in order to process those converted representations and possibly to merge them with plenoptic representations captured with plenoptic cameras and converted into the same camera independent plenoptic format.

When copping with standard 2D images and 3D models, we need to be able to convert them into the independent plenoptic representation so as to be able to merge them or process them the same way we would do for plenoptic captured data.

As it was the case above, we consider, for the sake of simplicity and clarity, a conversion into a two-plane representation.

### Conversion of a 1D or 2D Image Data

A 2D image with a specific width (W) and height (H) is composed of W*H number of pixels. Each pixel can be represented using a pair of 2D coordinates Ix-Iy and matched with specific coordinates Rx-Ry on the Rx-Ry plane. The intensities of the rays hitting these coordinates on the Rx-Ry plane will be replaced with the pixel values of the 2D image. More precisely, the matching between Ix-Iy and Rx-Ry is done by placing the 2D image on the Ry-Ry plane, i.e. Z=1, at the desired location on X and Y. Since a multitude of rays fairing from different points on U-V is intersecting the Rx-Ry plane at a specific coordinate, the intensity value of the 2D image pixel placed on that Rx-Ry coordinate is copied to all the rays passing through that coordinate. Each pixel of the 2D image is therefore converted to a physical point having light rays fairing in different directions but with a same intensity.

The approach is also available for synthetic images. Assuming a specific width (W) and height (H), they are composed of W*H number of pixels like a standard image, each pixel being matched with a specific coordinates Rx-Ry following the same process as above.

A 1D image can also be converted to a light field. The process is the same as above except from the fact that we only consider one dimension (e.g. Ix) instead of two (e.g. Ix-Iy).

Considering a video as a succession of 2D frames, each frame can also be converted into a light field following the exact same principle as described above.

Conversion of a 3D Model into Plenoptic Data in a Camera Independent Format

A 3D model can also be converted into a light field. One first approach is to integrate the 3D model as 3D points in the independent representation. As for the case of the 1D or 2D images above, light rays fair from each 3D points of the 3D model in different directions. The ray intensities in the different directions is defined by the 3D model parameters. In a simple case, all the ray intensities would be the same in every direction (lambertian model), but it might not always be the case. Once we know all the rays fairing from each 3D point in space, we need to compute their intersections with the Rx-Ry and U-V planes to compute the intersections for the independent representation. Note that since we have a 3D model, we can deal with occlusions and therefore we only retain the rays which can be directly seen from the U-V plane. Those rays intersecting the U-V plane are then extended to the Rx-Ry plane, where their intersections are computed. This way, we simulate the view of the 3D model by a plenoptic camera. This approach has the disadvantage that each possible viewing condition of the 3D model needs to be taken into account and represented in the independent representation, which might cost some memory space. However, since all possible views have been pre-converted into the independent representation, there is no additional processing time required when willing to make use of them.

In another embodiment, one converts a 3D model into a camera independent representation only when willing to make use of it. In that scenario, we do exactly the same processing as above but only for the desired viewing conditions. As a consequence, the required memory space is less but some latency might be introduced due to the on-demand conversion of the 3D model for some post-processing.

### Light Field Processing

The output of the above mentioned conversion process is a representation of a light field which is camera independent and directly usable for further processing. Indeed various cameras having large fundamental hardware differences, it would be complicated to maintain method and algorithms for post-processing directly applied to this camera-produced data. As proposed in this invention, the different transforms presented can be used to free the post-processing algorithms from the camera specificities.

We will now describe several post-processing methods allowing the converted light field to be modified. This can be for doing augmented reality or to improve the scene quality.

### Scene-Centric Representation

The light field representations uniquely describe each light ray in space based on the camera position. Depending on the representation, a light ray direction might also be included in the case that the capture system can gather light within a field of view >=180°.

This camera-centered representation can be processed to be centered on any object of the scene. Indeed, light rays comes from scene objects such as light sources our other objects reflecting direct or indirect light sources. In order to process the captured and transformed light fields, it is useful to have such a scene-centered representation in order to be able to modify the light rays when an object is added, removed or modified.

For example, in an augmented reality processing, one often needs to augment the captured light field with some virtual/artificial visual information. In the present description, augmented reality also comprises situation where one actually remove an object from a scene, which is sometimes called diminished reality.

Throughout the next section we use the example of a representation of the light field with the above described two-plane parametrization but the same method can be equally applied to other representations such as for instance sphere-plane.

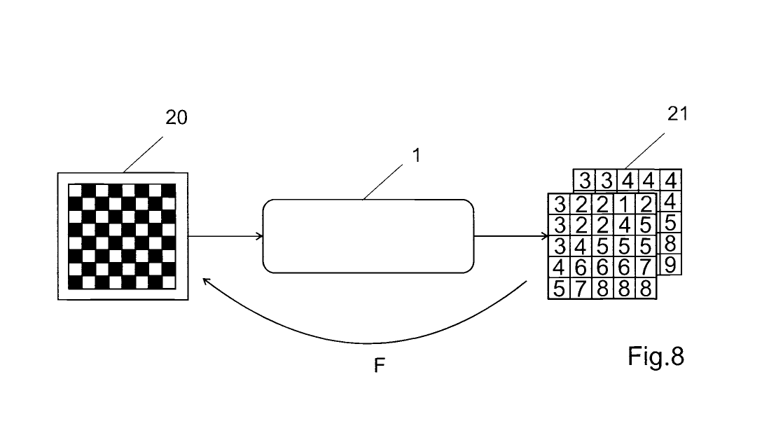

FIG. 9 illustrates a two-plane representation of a light field from a scene 20. Four rays r₁ to r₄ are illustrated. The first two r₁, r₂ correspond to an in-focus point A in the focal plane Rx, Ry of the camera 1, where the last two r₃, r₄ correspond to a point B not in focus at a difference distance.

As previously explained, it is impossible to know from this representation which of the rays r₁ to r₄ are representing the same physical point or not. We propose here to transform this representation to a scene-centric one where the rays will be emitted by the scene 20 and would therefore start at the scene point, and stop when they hit the camera plane U-V. We are therefore dealing with segments instead of half lines representing light rays. This is the dual of the previously mentioned representation where rays are starting from the camera and are never stopping as their length or depth is not known.

The transformation can be done the following way:
1. Start with a scene-centric plenoptic representation of a scene
2. For each ray in the camera independent representation, do
   2.1 Estimate the intersection point of the ray and the physical point of scene (see next section for an overview of possible methods). Knowing this, we can infer the depth of the scene point.
   2.2 Deduce the 2D position of the physical point with respect to the camera, parallel to the camera plane (U-V plane).
   2.3 Search for the 3D point created by the 2D position+depth information computed in the first two steps.
      2.3.1 If this 3D point already exists in the scene-centric representation, add a new ray to the scene centric representation, starting from the 3D point and having the same direction as the current ray in the camera independent representation. The other properties of the ray (e.g. color intensity) are also copied.
      2.3.2 If this 3D point does not exist in the scene-centric representation, create a new point in the scene centric representation and attach it a new ray emitted from this point and having the same direction as the current ray in the camera independent representation. The other properties of the ray (e.g. intensity) are also copied.

The output of this transform is a point cloud having rays attached to each point. Each ray has a specific color intensity describing the color of the physical object, lit with the current light, seen from the viewpoint centered on the ray. This fully describes the scene geometry as well as its visual appearance.

This is worth noting that light rays directions do not depend on the scene but only depends on the capturing device. Therefore, for the same capturing device having the same intrinsic parameters, only the depth and color information of a ray in the camera independent representation will change.

With this new scene-centered representation we can actually modify the light field so that each modification of the rays would actually modify the visual appearance of the object at the center of the representation. A contrario, the camera independent representation does not include any information on the scene. Therefore, changing a ray property such as its color intensity would yield to a change in the captured scene without an actual relation with the scene itself.

### Inferring Depth

As mentioned in the above method for converting a light field to an object or scene centric one, one needs to have the depth information of each ray.

We present briefly here two methods for reconstructing depth.

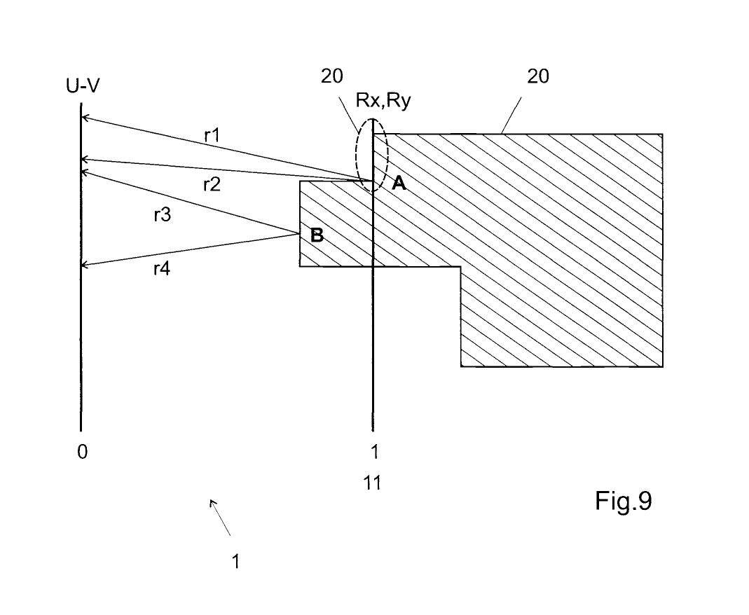

The main principle behind the first method illustrated on FIG. 10 is to identify which rays r₁, r₂, . . . , rᵢ come from the same physical point A. As soon as two rays (here r₁ and r₂) have been identified as corresponding to the same physical point A, the depth can be inferred using triangulation. This gives a depth estimate relative to the representation parameters. If absolute depth is needed, one need to have also the parameter linking the light field representation to the physical world.

In FIG. 10, one physical point A emits two rays, r₁ and r₂. A third ray r₃ not emitted by this point is also illustrated.

Following procedure could be used to infer the depth of a ray, say ray 1:
1. For each ray rᵢ in the scene other than r₁, identify if the ray belongs to the same physical object or comes from the same point A (see next paragraph for different methods).
2. Once a ray r₂ representing the same physical object has been identified, compute the distance of the purple point to the camera plane U-V by using the light field representation parameter for triangulating it. Indeed, the angles of the rays r₁, r₂ with respect to the camera plane U-V are known as well as their relative distance on the same camera plane.
3. Using trigonometric equations, we can infer the distance from the camera plane U-V and the point A, i.e. its depth.

### Ray-Object Identification

A method for assessing whether two rays corresponds (i.e. are emitted by) to the same physical object or point could be based on the assumption that the physical object surfaces are totally lambertian, i.e. the light reflected by the object is the same in all directions, for a given point on the object. By exploiting this constraint we build a similarity measure, which defines how well two rays are representing the same object. This is actually asserting the visual appearance, or more precisely the intensity, of each ray. Several measures can be used. One possible measure is the absolute difference defined as:

Measure_{AD}(Intensity_{Ray1},Intensity_{Ray2})=|Intensity_{Ray1}−Intensity_{Ray2}|

This measure can be used in the step 1 of the above procedure to determine whether or not two given rays are representing the same object. The smaller AD values represent those cases.

It is worth noting that by using only the ray intensity as a measure of similarity, it is highly prone to noise. It is therefore wanted to reduce the effect of noise by applying an iterative process or consensus method to statistically and globally solve the depth triangulation problem instead of taking only two rays as the information needed to infer depth.

The second method is based on epipolar image representation of the light field and more precisely epipolar lines. We present below the method Epipolar line depth reconstruction method by leveraging the two-plane representation mentioned in this document.

### Depth Reconstruction Using Epipolar Lines

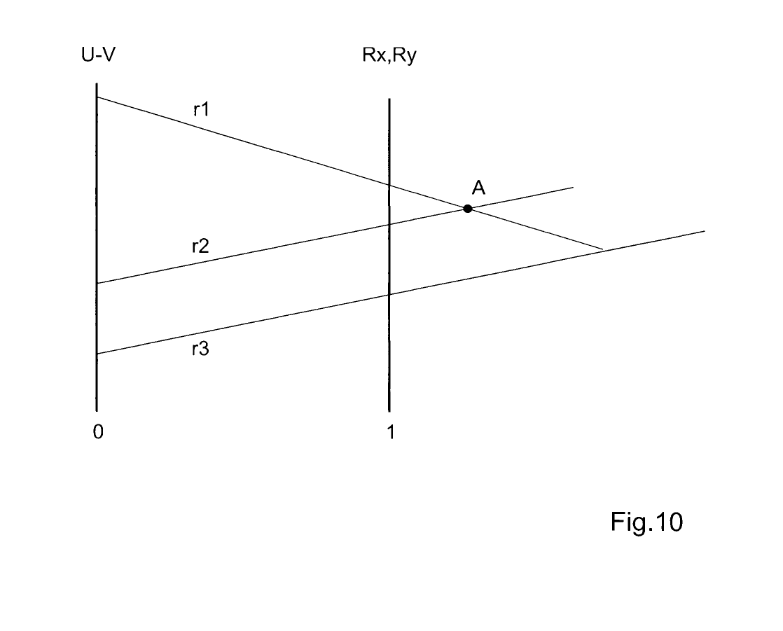

Assuming a lambertian model, physical points can be extracted in the Rx-Ry-U-V coordinate system using the method described with reference to FIG. 11.

A light field might be represented in Rx-Ry-U-V representation. A physical point A is placed at distance d from the Rx-Ry plane with the offset hₓ in the direction parallel to the Rx axis. We assume the physical point A is located in a plane with Ry=0 and V=0 for simplicity. The distance between the Rx plane and the U plane is δ, which equals 1 in our two plane representation The object A emits rays rᵢ. A ray intersects to both the Rx-Ry and the U-V plane but the positions of intersection are slightly different depending on angle of the ray.

The following equation holds because the triangle (d+δ, hx), (δ, Rx), (δ, hₓ) and the triangle (d+δ, hₓ) (0, u), (0, hₓ) are homothetic:

$$\frac{{R}_{x} - {h}_{x}}{d} = \frac{{U}_{x} - {h}_{x}}{d + δ}$$

Transforming the equation, we get a linear equation of Rx with respect to u:

$${R}_{x} = \frac{d}{d + δ} U + \frac{δ}{d + δ} {h}_{x}$$

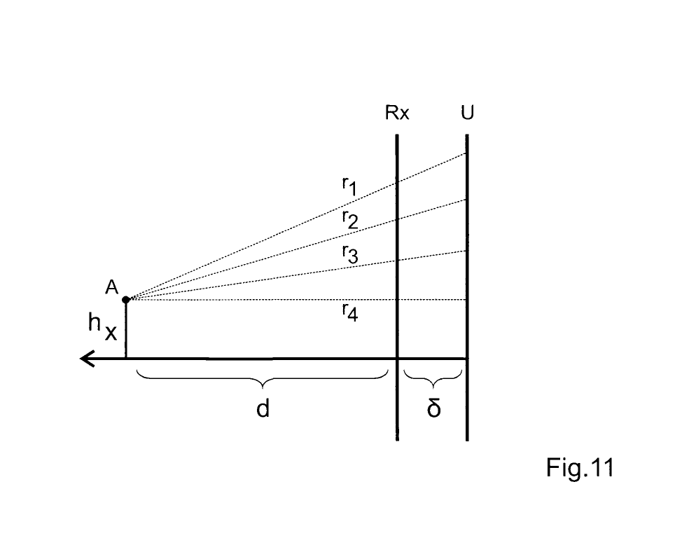

It means the light rays from the source forms a line L on the U-Rx plot, so called epipolar line, and its gradient is in function of depth. FIG. 12 shows the U-Rx plot.

By assigning 0 to U, the Rx intercept is derived as:

$${R}_{x} ( 0 ) = \frac{δ}{d + δ} {h}_{x}$$

Furthermore, the following equation holds for the gradient and depth:

$$gradient ( L ) = \frac{\partial {R}_{x}}{\partial U} = \frac{δ}{d + δ}$$

Therefore, we can obtain depth d and offset hₓ by extracting the line in the U-Rx plot and computing its gradient and Rx intercept.

### Epipolar Line Extraction

Several methods of extracting lines from 2D data (e.g. image) could be considered. The Radon transform is suitable to achieve this goal. Radon transform R of a function f(a, b) is defined as:

R(ρ,θ)=∫∫f(a,b)σ(x cos θ+y sin θ−ρ)dxdy

In Radon transform, the original image plane is transformed to a θ−ρ plane in which each point (θ₀, ρ₀) corresponds to a line x Cos θ₀+y Sin θ₀=ρ₀ in the image plane. The intensity of the point is then proportional to the length of its corresponding line. Algorithm 1 below shows the Hough Transform's algorithm which can be considered as an algorithm to compute a discretized version of the Radon transform.

The reason that the Hough Transform uses polar coordinates (i.e θ-ρ parametrization) rather than the familiar slope-intercept form is that both slope and intercept are unbounded even for a finite x-y plane (i.e. a digital image).

One key property of the Radon (and Hough) Transform is that rotation (i.e. change of θ) in the image plane is converted to a simple translation in the θ-ρ plane.

### Algorithm 1: The Hough (Radon) Transform Algorithm

Require: The two dimension matrix I representing an image.

1. Discretize the range of θ values in the vector Θ.

2. Discretize the ρ parameter into nρ distinct values.

3. Construct the Length (Θ)×nρ output matrix H.

4. Set all elements of H initially to 0.

5. for each feature point (x, y) in I do

6. for each θεΘ do

7. ρ=x cos θ+y sin θ

8. H(θ, ρ)=H(θ, ρ)+1

9. end for

10. end for

11. return the output image H

As a result of the Hough Transform, the Epipolar lines are characterized by θ and ρ, where the following relations hold:

$$- sec θ = gradient ( L ) = \frac{d}{d + δ}$$

$$\frac{ρ}{sin θ} = {R}_{x} ( 0 ) = \frac{δ}{d + δ} {h}_{x}$$

Accordingly, the desired parameters d and hₓ are obtained as:

$${d}_{i} = \frac{sec θ}{1 + sec θ} δ$$

$${h}_{xi} = \frac{( d + δ ) ρ}{δ sin θ}$$

$${h}_{yi} = \frac{d + δ}{δ} {R}_{y}^{′}$$

### Depth Reconstruction Algorithm

In the real world, an object can be placed at an arbitrary position in the 3D coordinate, which means a depth estimation method needs work not only for points on the plane of Ry=0 and V=0 but also at any point. In order to take into account the offset h_{y} of the physical point in the Ry (or V) axis, we perform the depth reconstruction on the U-V plane for all possible Ry values. In other words, we extract epipolar lines on the U-V slice at each Ry, where V=0.

In accordance with the principle described in the section above, we propose an algorithm to reconstruct the geometry of a captured scene.

Require: A plenoptic data represented in UVRxRy coordinate system.
1. For each Ry as Ry′
2. Apply the Hough transform on the U-Rx plane at (V, Ry)=(0, Ry′)
3. For each extracted epipolar line, compute depth dᵢ, x offset hₓᵢ and the y offset h_{yi}

$${d}_{i} = \frac{sec θ}{1 + sec θ} δ$$

$${h}_{xi} = \frac{( d + δ ) ρ}{δ sin θ}$$

$${h}_{yi} = \frac{d + δ}{δ} {R}_{y}^{′}$$

4. Return all the inferred 3d points (hₓᵢ, h_{yi}, dᵢ)

### Applications for Augmented Reality

This scene-centric representation allows to perform modifications and/or improvements to the captured light field in a way that is compliant with the physics of the scene.

We give here two different examples. The first is about improving the image quality of a specific scene element. It is often wanted to select an element of an image, such as an object or a well delimited part of the scene, and to have a specific part of an image brighter, darker, with more contrast or with different exposition settings. In order to apply the wanted picture correction in a conventional imaging system, let's take the brightness, the user has to manually select which pixels have to be modified so that the filter is only applied on these pixels. It can be really cumbersome in a lot of cases (take the example of a person's hair).

With a light field capture of scene transformed as just explained in this section, one can select elements not only based on their visual appearance but also with respect to their physical position in the scene space. With this system the user do not select pixels but points in space. The system can then help the user select all the points belonging to a specific object by analyzing the depth discontinuities of the scene points cloud in order to segment each object. In the previous hair example, the user would therefore only click on the person's head to have his entire head corrected by the applied filter. The different rays “emitted” by the persons head would be selected and corrected according to the filter, in this case a brightness filter which would increase the color intensity of each ray.

By having this two steps transform (camera light field->camera independent light field->scene-centric light field), the different filters are totally independent of the camera and can be easily applied to the scene itself in such a way that they respect the different physics law of the scene as both the geometry and the lighting information are known.

The second example is about doing augmented reality in the light field space. Augmented reality is about changing the scene with additional/other information. Therefore there is a direct “physical” link between the change in the scene and the content to be added. Let's take the example of a light field capture of a street, done at the level of pedestrian. The example use case given here is to replace an object, such as an existing building, with another object, such as a newer building to be built up. The newer object takes the form of a computer generated virtual 3D model with textures and surface information such as reflectiveness and so on. The goal is to have this 3D model perfectly put in the light field capture so that it replaces the current object.

The following process can be used for that purpose, given a scene-centric representation of the light field:
1. The user select the main frontage of an object, such as a building, in the captured light field scene. This creates an anchor point in the point cloud representation of the scene
2. The system places the virtual 3D model in the scene so that the main frontage of the object in the captured light field overlaps with the one of the virtual 3D model
3. Thanks to the 3D information of the virtual 3D model and the depth information contained in the light field point cloud, the system can infer which rays are representing the object in the light field captures, and therefore which rays have to be replaced by the one representing the virtual 3D model.
4. The system merges the virtual 3D model rays with the one of the scene to create a near-real representation of the scene with the new object artificially put into it.

The above procedure can be used to add/change objects in a light field. In an augmented reality scenario, there are usually two steps involved: 1) based on a single light field capture, a user A modify the scene by either removing elements or by adding new elements, directly linked with the physics of the scene, and 2) a user B take another light field capture (or a video of it, or a continuous real-time capture) so that the scene is automatically changed (or annotated per se) based on the previous user input. The first step can be done using the above 4-steps procedure. The second one involves being able to register the light field captured by user A with the one captured by user B. After the registration we exactly know the mapping between scene A rays and scene B rays. The step number 4 of the above procedure can therefore be automatically applied to create an augmented version of user B's scene based on user's A modifications of the scene. This is called light field based augmented reality.

### Diminished Reality Based on Light Fields

In certain scenarios, it is often desired to modify a captured light field representing a scene in order to remove real objects from it.

Removing an object from a scene requires a certain knowledge of the scene. For example, removing a cube from scene, requires the method to know how the background looks behind the cube (with respect to the camera plane position).

This is where light fields can become useful. Indeed, we have more information about how the scene looks from different side and we would be therefore able to reconstruct the “behind of the object” more easily.

Removing an object therefore requires two different steps:
1. Identifying the object to remove. This requires to exactly know which rays of the light field corresponds to the object. This process is called segmentation.
2. Replacing the object rays by rays that would imitate the background of the object. This is called inpainting.

We now present hereafter methods to accomplish the above two steps in the two-plane representation of light fields describe here above.

### Segmentation

In order to identify which rays belong to the object we want to remove from the scene, we perform a task called object segmentation in order to have a better “semantic” understanding level of the scene. For that matter, we start with a scene-centric light field representation, explained in the previous sections.

Having this representation on hand, we seek to identify which rays emitted by objects of the scene actually belong to the same object. Several methods exist to do that, specially coming from the object segmentation from stereo vision fields. These methods can also be applied in this scene-centric light field case with the main advantage that depth estimation is usually of better quality due the additional quantity of information captured by a light field capturing device. This yields to a better segmentation result.

A typical object segmentation algorithm working on a scene-centric light field would work as follow:
1. Represent each light ray emitting point as 6D vector, 3 dimensions representing the position of the point and 3 other being the average of the light intensities (or color) of all the rays going out of this point. It is worth noting that instead of averaging the intensities, the algorithm could also quantize them to have one intensity per light ray emitting direction, out of a set of predefined directions. Setting the number of directions to N would create a N+3 dimensional vector representing the emitting point.
2. Cluster this set of 6D point based on distance that typically weight differently the cost of a geometric inconsistency than a color inconsistency. More weight would typically put on the first one.
3. The result of the clustering is made of clusters, each one representing a different object on the scene. The last step of the algorithm is to assign, to each ray of the scene, an object identifier corresponding to the cluster to which the rays belong to.

After having all the rays associated to objects, the object to be removed has to be chosen. This can be done for example by presenting to the user an image of the scene and allowing him to click a region. By back projecting the click on the scene we can know to which object the click has been applied to and therefore identify the rays belonging to that object.

We will now describe a typical use-case where the object segmentation in scene-centric light field representation might be useful:

A light field scene captured by a plenoptic camera has a specific angular and spatial resolution. Both resolutions are mainly due to the camera intrinsic parameters. A similar scene taken with two different plenoptic camera parameters might have different angular and spatial resolutions. Assuming they have the same spatial resolution, the perspective from a scene captured with different camera parameters such as a short focal lens and the average focal lens might be different.

Assume a photograph capturing the scene with a given perspective using specific plenoptic camera parameters with a given short focal lens (for instance 24 mm). With a second longer focal lens, such as a 100 mm, he captures again the scene with another perspective. On both captured scenes, the object of study is present in the foreground but might be seen with two different perspective views. Assume now that the photograph wants to capture the scene with the foreground having the same perspective as in the first image but the background having the perspective of the second image.

To achieve that, one possibility is to change physically the position of the capture for both images. The first image is captured from one position with some camera parameters. On that image, the foreground has some particular perspective. On the second image, the photograph wants the foreground having a similar perspective as in the first image (hence the physical capture position has to be adjusted) but the background with another perspective. For that, he needs to physically move around to be able to capture such a visual effect, which is of importance in photography.

An alternative for that approach is to process the scene after the capture. By capturing the scene using a plenoptic camera, this becomes possible. Indeed, the object in foreground can be isolated from the background using segmentation techniques. Then the foreground and background of the image can be processed separately and therefore a filter can be applied specifically to the foreground or background. We can imagine to design a filter which does not change the perspective of the foreground of the image but having a second filter which does change the ray parameters of the background to compute a new perspective. The computed image will therefore contain the foreground with the original perspective and the background with another perspective.

In order to reduce the computation cost the scene-centric representation might be applied only on a part of the image where the object is located. All rays related to that object will be distinguished to others on which a filter will be applied. The filter might simulate camera parameters such as a specific focal lens, processing a new angular and spatial resolution applied on the scene, excluding the object of study.

### Light Field Inpainting

The last step of the diminished reality processing is to transform the rays identified in the previous step to make them appear as if they were emitted by the background of the object to remove.

In the standard image processing field, replacing pixel with ones which should look the same as the texture which would be behind an object is called as inpainting. We present here the general concept of the method and how it can be applied to our scene-centric light field. More details can be found in http://hci.iwr.uni-heidelberg.de/Staff/bgoldlue/papers/GW13_cvpr.pdf (in painting example is given in section 6 of the paper).

The main idea of in painting a light field is to recover the missing information of the light field. In one case, the missing information are the area represented by the rays of the selected object. Those rays can be removed and the light field reconstructed by assuming that those object rays are missing. This problem is stated more formally as follow, assuming that the mussing region F corresponds to the rays of the object which are beforehand removed from the captured light field named F.

As a second example, we discuss inpainting on ray space. Let Γ⊂ [symbol] be a region the ray space where the input light field F is unknown. The goal is to recover a function U which restores the missing values. For this we find:

$${arg min}_{U} {J}_{λ μ} ( U ) such that U = F on Ω \backslash Γ .$$

Solving this optimization/regularization problem gives a solution on how the different light rays emitted by the background are. The scene can therefore be re-rendered using the recovered light field which would appear as the same scene as before but without the object.

### Cropping

Cropping of a plenoptic image corresponds to selecting a range of four parameters Rx, Ry, U, V. In addition to 2D image cropping, where cropping is similar to perform the cropping on the Rx-Ry plane, plenoptic cropping allows to crop images on the U-V plane as well as the Rx-Ry plane. Setting a range for each parameter Rx, Ry, U, V, one can select a subset of the light rays from the entire set of light rays. A possible implementation of cropping is the angle-based cropping, which allows to restrict the viewing angle of an object. It might be used in the case that user attaches a plenoptic annotation on a plenoptic image such that the annotation appears only from a certain viewing area. the angle based cropping takes input of the 3D position (x, y, z) of the attached object and two angles (φ, θ) to restrict the viewing area, and outputs the corresponding range of Rx-Ry and U-V.

The range of the Rx-Ry plane is determined as:

Rₓε[−|z−δ|tan θ+x,|z−δ|tan θ+x]

R_{y}ε[−|z−δ|tan φ+y,|z−δ|tan φ+y]

where z is the perpendicular distance to the U-V plane and x, y accords to Rx, Ry. θ and φ are the horizontal and vertical angle from the line perpendicular to the U-V plane respectively.

Similarly, the range of the U-V plane is calculated as:

Uε[−|z|tan θ+x,|z|tan θ+x]

Vε[−|z|tan φ+y,|z|tan φ+y]

### Ray Intensity Modification

Ray intensity of a plenoptic image can be modified globally and locally.

Global ray intensity modification allows user to adjust brightness, color balance, contrast, saturation, etc of a plenoptic image and the modification is applied on all the rays uniformly. More advanced processing, such as automatic image enhancement by analyzing and optimizing color histograms, can also be performed on the plenoptic image.

Local ray intensity modification allows user to select an interesting region of a plenoptic image in terms of both scene (i.e. Rx-Ry plane) and viewing point (i.e. U-V plane) then apply a modification listed above within the selected region.

### Ray Filtering

Similarly to filtering 2D images, it is also possible to apply filters on plenoptic data. A low-pass filter such as Gaussian blurring filter is interpreted as diffusion of light rays in the light filed. Filtering 2D images is represented as convolution of an image and a 2D filter element, likewise filtering plenoptic data is represented as convolution of a plenoptic image and a 4D filter element.

$${P}^{′} ( {R}_{x} , {R}_{y} , U , V ) = H * P = {\sum }_{i , j , k , l}^{ } H ( i , j , k , l ) P ( {R}_{x} - i , {R}_{y} - j , U - k , V - l )$$

where H is the filter element.

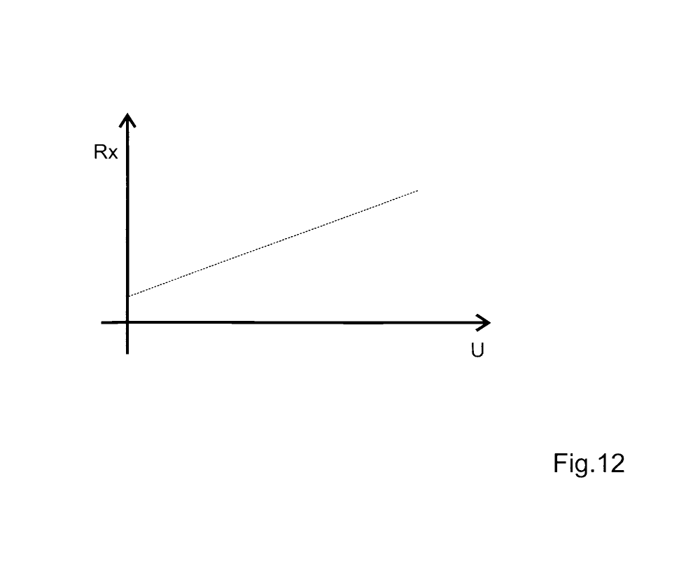

FIG. 13 shows an example of Gaussian filter for the U-V plane, which diffuses light rays passing through a single point (Rx, Ry) and hitting to the U-V plane.

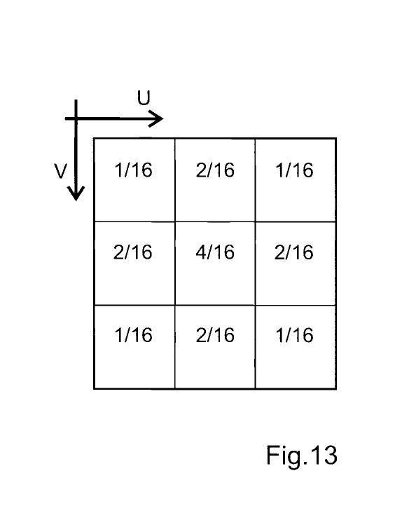

As a result, the object A filtered with filter F looks blurred as depicted by A′ in FIG. 14. In this example, as one can notice from the figure, objects near the Rx-Ry plane becomes less blurred and those far from the plane becomes more blurred. Furthermore, it is possible to maintain objects at a certain depth sharply while blurring all the other objects by constructing an appropriate filter element.

### Resizing

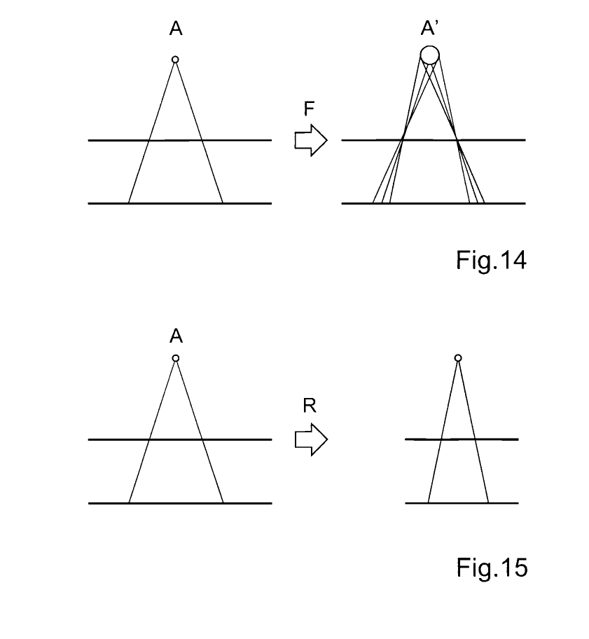

Resizing of plenoptic image is defined as rescaling unit of the parameters. Likewise resizing 2D images, the resizing process R for resizing object A illustrated on FIG. 15 transforms a value on an axis to the product of the value and a scaling factor,

P(Rₓ,R_{y},U,V)→P(σ₁Rₓ,σ₂R_{y},σ₃U,σ₄V)

where σᵢ is the scaling factor.

For instance, if (σ1, σ2, σ3, σ4)=(0.5, 1, 0.5, 1) then the output looks shrunk to half in the Rx (or U) direction at every viewing point. FIG. 17 shows the schematic of resizing the Rx-Ry and U-V planes to a half size.

### Perpendicular Translation of the Planes

Light rays of a captured scene are parametrized by Rx, Ry, U, V in the two-plane representation, and the U-V plane represents the viewing position. One can vary the viewing position arbitrary on the plane and acquire the corresponding Rx, Ry values. However one might want to not only move within the plane but also out of the plane. This case happens when one tries to move the viewing position closer to an object.

The entire light ray parameters need to be recomputed since the two planes need to be shifted along their perpendicular axis in order to change the viewing position into a point out of the U-V plane. The computation of new parameters could be performed as follows:
a) shift the two planes such that the new viewing point lies on the U-V plane along their perpendicular axis,
b) compute the new intersecting points with the two planes for all light rays

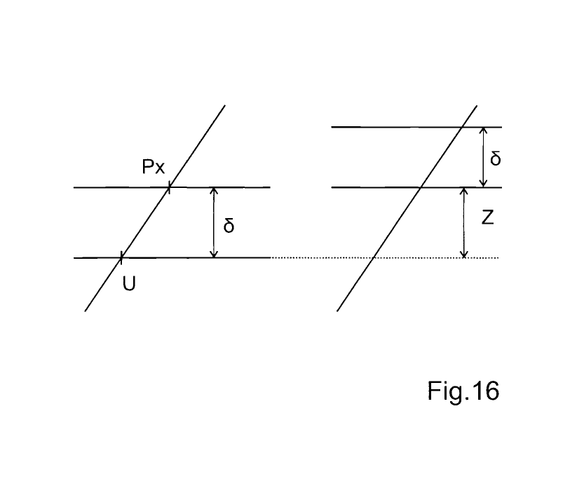

Since this is a linear operation, the computation can be described as a matrix multiplication to vectors of the input parameters. The values of matrix is calculated from the distance between two planes δ and the translation factor z. FIG. 16 briefly shows the schematic and the translation matrix.

$$[ \begin{matrix}{U}^{′} \\ {Rx}^{′}\end{matrix} ] = \frac{1}{δ} [ \begin{matrix}δ - z & z \\ - z & δ + z\end{matrix} ] [ \begin{matrix}U \\ Rx\end{matrix} ]$$

### Refocusing

The captured light field might be taken with a specific object focal plane. Since we capture rays coming from different directions from the same physical points, we can rearrange the rays so as to recreate refocusing.

In the device independent representation, this can be done by moving the Rx-Ry plane and computing the new intersections of the rays with this new plane. One can note that this process is equivalent to the normalization process necessary when we build the independent representation.

### Fusion of Plenotic Data

As described in the section above, a light field is composed of a finite number of parameters. In the example of the two-plane representation, a ray is described by 4 parameters for the intersections with the U-V and Rx-Ry planes and its ray intensity. The coordinates value of the 4 intersection parameters can correspond to different representations, as for instance the two plane representation or the spherical one. Thus, when fusing data corresponding to two plenoptic image, we need to take into account the case that their representations are different.

Two plenoptic data with different representations can be merged or fused by converting the second plenoptic data in the second representation to the equivalent data in the first representation and fusing the two data in the first representation. Depending on the data representation, the sampling of the converted data might not be the same as the one of the second data. In this case, quantization may need to be applied on the plenoptic data to cope with different samplings.

In the quantization process, each parameter is assigned to a small bin whose size corresponds to the distance of two sampling points in a coordinate. For instance, if the number of samples on the Rx axis is 640, then the area to be merged on the Rx axis is divided into 640 bins and the Rx value of each ray which hits the area is quantized into one of the bins. It might happen that two different light rays are quantized to the same bin, which means all the quantized parameters of the originally different rays become identical. In this case, we need to decide on a fusion process, which could be for instance to select one of the rays based on certain criteria or merge them to obtain the averaged ray intensity. As another problem, all the bins might not be filled with intensity values but some remain empty. In this case, the value at the empty bins can either be filled with interpolation by neighboring bins or remain as no value. Various interpolation methods are possible. Bilinear interpolation is one example.

### Light Field Storage

Since the intensity value of a light ray in the two-plane representation is parameterized using 4 parameters (e.g. Rx, Ry, U, V), we can store the entire captured light field by storing all the intensity values and their corresponding parameters. The 4 parameters can take any real values. An intensity value can be defined for each color red, green and blue or any other value in other representations such as HSV or CMYK. Therefore, a light filed can be stored in a matrix-like format, where its row corresponds to each light ray and its column corresponds to each parameter or intensity value respectively. Assuming that a light ray has one intensity value, the size of matrix equals to 5 (i.e. 4 parameters+1 intensity value) times the number of light rays to be stored.

However, as plenoptic data is usually captured using normal imaging sensors arranged side by side at a constant interval, we can exploit this a priori knowledge of the structure of camera to optimize the storage required. Thus, under this condition, using a traditional image format to store the captured plenoptic field can be advantageous. In this format, the two-plane representation presented in the beginning of this document is well suited.

Storing the light field using an image-like format requires the two-plane representation parameters to be known in advance. Those parameters could also be stored in the image using metadata but as we need a camera independent representation, the parameters are usually known a priori. Those parameters include the distance between the two planes and the sampling rate of the rays (corresponding to micro lens and imaging sensor parameters).

Having the representation parameters fixed makes the different rays represented in between the two planes completely independent of the scene. Indeed a scene A different from a scene B will have the rays directions represented by the two planes. The only changes are in the rays intensities, which obviously will change as they are representing different objects.

To store such a two-plane representation, a traditional image format can be used. The image is composed of pixels, each pixel representing a ray hitting the U-V plane. The 2D cartesian coordinate system of the image is directly mapped to the U-V plane coordinate system, making the relation between the U-V plane and this image storage completely straightforward. The number of pixels of the image corresponds directly to the sampling rate of the U-V plane, which is equal to the number of rays hitting this latter plane.

A format to efficiently store a light filed can be constructed for another type of representation, such as the spherical representation by exploiting the characteristics of the representation.

To exploit this storage format in a real-time system, one can use a pre-computed look-up table making the correspondence between one pixel in the image, corresponding to one ray, with its ray direction. Thanks to that, obtaining ray direction at run time comes down to retrieving a value from a pre-computed look-up table that is common to all captured light fields.

### Visualization of Plenoptic Data

Visualization of stored light rays is a necessary step to enable human to perceive the scene represented by the rays. Though visualization can be performed in various ways, for instance holographic visualization, we consider in this section, without loss of generality, ordinary 2D visualization (i.e. rendering) which visualize a scene as single/multiple 2D image(s). The stored light field in our example of the two-plane representation can be visualized by projecting the 4D light rays which hit a certain viewing position onto a 2D surface. A 2D image is generated by searching for the intersecting point of each ray with the surface and assigning its intensity value into the corresponding pixel of the 2D image. The simplest example is the rendering of light field stored in the Rx-Ry, U-V representation. In this case, the Rx-Ry plane corresponds to the surface where light rays are projected (i.e. image plane), and a point on the UV plane corresponds to the viewing position. By assigning the intensity value of each ray intersecting at point (U, V) on the UV plane into point (Rx, Ry) on the image plane, we obtain the rendered image of the captured scene viewed by the viewing position (U, V).

The viewing position can be placed at an arbitrary position. The change of the viewing position is called perspective shift. For instance, in the case of the Rx-Ry-U-V representation, perspective shift is conducted by changing the viewing point (U, V) to another viewing point (U′, V′) on the U-V plane. Rendering a light field with perspective shift induces of a visual effect that the camera position translates to a new position.

As well as to display a 2D image of a scene on a screen, light field rendering can be used for more advanced use cases. For example, a 3D view of a scene is simulated by generating two images from two viewing positions with interpupillary distance apart and displaying one for the right eye and the other for left eye respectively. There already exist technologies to display stereoscopic images such as shutter 3D system and autostereoscopy.

A plenoptic viewer can be used to present data to the user as recomposed 2D images. Possibilities to refocus the plenoptic scene to a particular focal point or to change the scene view point are given to the user. The plenoptic viewer makes a direct use of the rays captured by the plenoptic device without interpreting them and therefore is not prone to errors as it is in the case of 3D reconstruction. Indeed, this direct use of the rays do not make any assumption on the reflectiveness or texture of the scene objects.

The change of focal point can be done by directly clicking on a point in the presented 2D image to adjust the focus on that point. Alternatively, the user could use a scroll wheel to change the focal point in the scene. This is visually similar to a scanning of the image, where the points in focus are sharped and the rest are blurry. Let us not that this ability to refocus the image at a focal distance has the property to see behind objects which are hidden by occlusions. From a user perspective, this is similar to scanning a scene along the different focal planes regardless of whether occlusions are present or not. This is a powerful property where using such a Plenoptic Viewer one can see through bushes, or through a dense volume of particles.

A plenoptic viewer can also render different views by changing the view point in the 3D space. The view point change can be for instance triggered by a click and drag action of the user mouse on the scene. This way, the plenoptic viewer changes the view position according to the new position of the mouse until the mouse button is released. Alternatively, keyboard keys could be used as triggers to change the view position depending on the pressed keys. A simple example would be to use the keyboard arrows for this action.

Once the user has decided upon the scene focal point and the view position, he can then annotate the scene elements. A user may attach an annotation only to the scene elements which are in focus in the current 2D view of the plenoptic viewer, which makes more sense to him. A user could also annotate blurry parts of the 2D view.

To annotate the scene, the user may drag and drop an annotation on the 2D viewer. The annotation can be taken from a list of possible annotations, or uploaded to the viewer or created on-the-fly. The selected annotation appears integrated in the plenoptic viewer. The system has merged the rays properly with the scene rays. The user can then apply some transforms to it directly in the plenoptic scene environment. The transforms can be 3D translation, rotation or scaling. Those transforms are for instance triggered by buttons or keyboard keys.

In the plenoptic viewer case, the merging of the rays between the annotation and the scene is done directly at the annotation level as the viewer directly works with the rays information.

The recorded plenoptic data can also be visualised in a 3D viewer. The recorded scene can be shifted and manipulate on three dimensions. It permits to the user an intuitive navigation into the scene space. Since only a part of the real-world has been captured, the reconstructed 3D scene might be crackled since some data of the scene is missing.

All captured rays may be used to compute that 3D map. Each generated coloured pixel will be positioned into that 3D space. Plenoptic image has the key feature to be focusable afterwards. In other terms, the user can select which areas he wants on focus. So that stored data can be also seen as a stack of images with different sharpest areas. Using each image focal distances, their relative positions can be known. All images from that stack are used to compute the 3D map. For each image, only pixels from sharpest areas are considered and since the selected image focal distance is known, these pixels could be repositioned in to a 3D map. That computed map will be composed of pixels from multiple images, positioned on several planes, giving a impression of depth. Actually, more advanced techniques exist in the literature to compute sophisticate 3D map using plenoptic image. The research field is quite active in that field. A key advantage of plenoptic cameras being the angular resolution, advanced maps can be built reducing as much as possible partial occlusions.

Applications where AR Finds Interests in the Plenoptic Space.

### Microscopy Field

Microscopy is probably the field where using plenoptic technology is currently the most appropriate. Standard optical systems fail in presenting efficient solutions due to optical limitation (reduced depth of field, too long light exposure for cells or neurons . . . ). For instance, as the analysis of cells is a fastidious process, being able to annotate, for instance by labelling cells, shows a strong interest.
Plenoptic increases depth of field (by a factor 6).
In case of occlusions, plenoptic can resolve the information at different layers, where other depth devices cannot.
Plenoptic reduces light exposure for the cell as it captures more view angles at once (good for living neurones).
Plenoptic increases the resolution of the images (by a factor 8).
No need for realistic annotations.

### Particle Velocimetry Measurement

The measurement of 3D trajectories is a difficult problem to tackle in several fields. When trajectories of multitude particles are tracked in a same volume such as water, it becomes a tedious work to analyse all different paths. Plenoptic devices have the strong advantage of looking at a scene with thousands of micro-eyes and therefore being able to resolve the multitude of occlusions that appears during the particles movement. Adding the possibility to annotate particle in the scene for a real-time tracking has strong interests.

In case of occlusions, plenoptic can resolve the information at different layers for a better 3D trajectory analysis.

No need for complicated calibration anymore with multiple very accurately aligned cameras. Only one unique camera to set up.

No need for realistic annotations.

Aquatic analysis of fishes in aquariums.

### Plants Grow Analysis

Efficient creation of new plant species is possible thanks to plants analysis laboratories where the searchers analyse plants evolution and investigate new solutions. The need for 3D analysis is strong, however, the cultures are done in a controlled environment where for instance light is an important parameter. The plenoptic technology solves well that problem of 3D analysis is such a controlled environment as it is non-intruisive and does not need to modify illumination conditions for reconstructing robust 3D models. As a known property, plenoptic devices deal well with multiple occlusions which is of the main interest in that field as well.

Plenoptic cameras can resolve the 3D information using current lighting of the scene. In such scenarios, adding illumination to the scene will alter the plantation development.

In the case of occlusions, plenoptic can resolve the information at different layers for a better 3D analysis.

No need for realistic annotations.

### Street View Advertisements

Those points below are Use Cases where further investigations need to be done. Some technical issues such as illumination analysis could not be yet tacked with our current understanding of the technology.

Use plenoptic technology to remove reflexions in store windows. Realistic advertisement on shop windows (e.g. Street View) with the combination of Vidinoti-1 & Vidinoti-7 for accurate positioning.

### Realistic Design and Architecture

Create realistic annotations by imitating surface's texture where the annotation is applied on: architecture simulation, furniture/walls colour in the scene's lighting . . . . Non-intrusive (meaning well integrated) advertisements during broadcasted sport events (e.g. advertisements on the ice during hockey games).

### 3D Avatar for Phone Calls

On-the-fly quick 3D avatar during phone calls.

The various operations of methods described above may be performed by any suitable means capable of performing the operations, such as various hardware and/or software component(s), circuits, and/or module(s). Generally, any operations described in the application may be performed by corresponding functional means capable of performing the operations. The various means, logical blocks, and modules may include various hardware and/or software component(s) and/or module(s), including, but not limited to a circuit, an application specific integrated circuit (ASIC), or a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein.

As used herein, the term “determining” encompasses a wide variety of actions. For example, “determining” may include calculating, computing, processing, deriving, investigating, looking up (e.g., looking up in a table, a database or another data structure), ascertaining, estimating and the like. Also, “determining” may include receiving (e.g., receiving information), accessing (e.g., accessing data in a memory) and the like. Also, “determining” may include resolving, selecting, choosing, establishing and the like.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A software module may consist of an executable program, a portion or routine or library used in a complete program, a plurality of interconnected programs, an “apps” executed by many smartphones, tablets or computers, a widget, a Flash application, a portion of HTML code, etc. A storage medium may be coupled to a processor such that the processor can read information from, and write information to, the storage medium. In the alternative, the storage medium may be integral to the processor. A database may be implemented as any structured collection of data, including a SQL database, a set of XML documents, a semantical database, or set of information available over an IP network, or any other suitable structure.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

It is to be understood that the claims are not limited to the precise configuration and components illustrated above.

Various modifications, changes and variations may be made in the arrangement, operation and details of the methods and apparatus described above without departing from the scope of the claims.

1. A light field processing method for processing data corresponding to a light field, comprising:
capturing with a plenoptic camera initial data representing a light field in a format dependent from said plenoptic camera;
converting said initial data into converted data representing said light field in a camera independent format;
processing said converted data so as to generate processed data representing a different light field.

2. The method of claim 1, wherein the direction of each light ray in said light field is parametrized in said camera independent format by exactly four parameters.

3. The method of claim 2, wherein the direction of each light ray in said light field is parametrized in said camera independent format with the positions where said light ray intersects two pre-defined planes.

4. The method of claim 2, wherein the direction of each light ray in said light field is parametrized in said camera independent format with the positions where it crosses two spheres tangent to each other, one of said positions being the tangent point.

5. The method of claim 2, wherein the direction of each light ray in said light field is parametrized in said camera independent format with the two positions where it crosses one single sphere.

6. The method of claim 2, wherein the direction of each light ray in said light field is parametrized in said camera independent format with the intersection of one plane with one sphere.

7. The method of claim 2, wherein each light ray in said light field is parametrized in said camera independent format with the distance of the closest point on the ray from the center of a sphere, the polar coordinates of this closest point with respect to the spherical coordinate, and the angle between the ray and a plane tangent to the sphere at said closest point.

8. The method of claim 1, comprising a step of converting each light ray of said light field from one said camera-independent representation to a different said camera-independent representation.

9. The method of claim 1, wherein said step of converting said initial data uses a conversion function depending on the model of the camera.

10. The method of claim 9, comprising a step of determining said conversion function using the plenoptic representation of a known scene.

11. The method of claim 1, comprising a step of processing a representation of a light field in said camera independent format to produce a scene-centered representation of the same light field.

12. The method of claim 11, comprising a step of modifying light rays of said scene-centered representation so as to modify the visual appearance of the object at the center of the representation.

13. The method of claim 11, further comprising determining the depth of a point by identifying a plurality of rays emitted by this point, and computing the distance to this point by triangulation.

14. The method of claim 11, further comprising determining the depth of a point by extracting epipolar lines.

15. The method of claim 1, said step of processing comprising applying a filter to the converted data representing said light field in a camera independent format.

16. The method of claim 1, said step of processing comprising recognising at least one image feature in said converted data, and adding to said converted data representing at least one augmented reality element depending on said feature, said data representing at least one augmented reality element being in said camera independent format.

17. The method of claim 1, said step of processing comprising selecting an object of the scene based on his position in space as determined from said converted data.

18. The method of claim 17, said step of processing further comprising replacing the rays emitted from the selected object.

19. The method of claim 11, said step of processing comprising performing an object segmentation by starting from said scene-centered representation, and identifying which rays actually belong to the same object.

20. The method of claim 1, said step of processing comprising resizing an object.

21. The method of claim 1, said step of processing comprising refocusing by moving the Rx-Ry plane.

22. The method of claim 1, said step of processing comprising:
retrieving second data corresponding to a different light field into a second camera independent format different from the format used for representing said converted data,
converting said second data into said camera independent data;
fusing said data and said second data,

23. The method of claim 1, further comprising a step of visualizing as single or multiple 2D or 3D images a light field stored in said camera independent format

24. The method of claim 23, said camera independent format comprising a representation of each ray by the position where each ray crosses two predefined planes, said step of rendering comprising a step of generating a 2D image in which each pixel corresponds to the brightness of the ray that crosses one of said plane at a given position.

25. The method of one of the claims 23 to 24, said step of rendering comprising applying a perspective shift in order to generate a view of said light field from an arbitrary position.

26. A light field processing apparatus for processing data corresponding to a light field, comprising:
a plenoptic camera arranged for capturing initial data representing a light field in a format dependent from said plenoptic camera;
a data converter for converting said initial data into converted data representing said light field in a camera independent format;
a light field processor for processing said converted data so as to generate processed data representing a different light field.

27. A computer carrier storing data processed with the method of claim 1.

28. A computer carrier storing program data causing a processor to carry out the method of claim 1 when program data is executed.

29. A method for processing data corresponding to a light field, comprising:
converting data representing said light field in first, camera dependent format, into converted data representing said light field in a second format in which the direction of each light ray in said light field is parametrized with the positions where said light ray intersects two planes or two spheres or one sphere and one plane;
processing said converted data so as to generate processed data representing a different light field.

30. The method of claim 28, comprising processing said converted data by merging with another light field representing data in said second format.

31. A computer carrier storing data representing a light field in a format in which the direction of each light ray in said light field is parametrized with the positions where said light ray intersects two planes or two spheres or one sphere and one plane.
